(19) United States
(12) Patent Application Publication
(10) Pub. No.: US 2015/0199773 A1
(43) Pub. Date: Jul. 16, 2015

(54) CREATING BUSINESS PROFILES BY THIRD PARTY USER ON-BOARDING

(71) Applicant: fisoc, Inc., Austin, TX (US)

(72) Inventors: Wesley Gottesman, Austin, TX (US); Mike Hall, Austin, TX (US); Daniel Edward Kim, Austin, TX (US); David H. Fruhling, II, Austin, TX (US); Brian Rainey, Austin, TX (US); Jay P. Valanju, Austin, TX (US)

(21) Appl. No.: 14/588,567

(22) Filed: Jan. 2, 2015

Related U.S. Application Data
(60) Provisional application No. 61/925,878, filed on Jan. 10, 2014.

(51) Int. Cl. G06Q 50/00; G06Q 30/02

(52) U.S. Cl. CPC G06Q 50/01; G06Q 30/0231

(57) ABSTRACT

Business profiles are created using information from third parties. A user is enabled to indicate a business type for one or more merchants, and a system prompts the user to input information relating to the one or more merchants. The system determines the validity of the input information, and when the validity of the input information is verified, the input information is transformed into directory information. Official merchant pages can thus be created by crowd-sourcing important and pertinent information, which will lead to a more extensive directory of businesses and allow users a more complete and enjoyable experience.

### CROSS-REFERENCES TO RELATED APPLICATIONS

This application claims the benefit of U.S. Provisional Patent Application Ser. No. 61/925,878, filed Jan. 10, 2014, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to creating profiles for businesses by third party, user on-boarding. More particularly, business pages will be created by user recognition of a business type, resulting in a data query utilizing details of a transaction conducted by the user at the business.

In previous iterations, business pages could only be verified and completed by outside research or business self-onboarding. However, this type of system requires either the use of extensive marketing or research. This limits the amount of businesses in any given directory as well as weakens user experience since they don't receive any information or support from non-registered businesses. It would be desirable to cut out these processes and enable official merchant pages to be created by crowd-sourcing required, important, and pertinent information. This change will lead to a more extensive directory of businesses and will allow users a more complete and enjoyable experience.

It would thus also be desirable for a system that could automatically and quickly create pages for businesses by crowd-sourcing information.

### BRIEF SUMMARY OF THE INVENTION

By accessing the user base's collective knowledge of their community, all necessary business information can be quickly and efficiently while also weeding out unnecessary information. In addition, as described in detail below, creating a process of determining information from crowd-sourced leads and reconciling the information with proprietary info would improve user experience and cut down company costs immediately upon implementation.

In an exemplary embodiment, a computer method of creating business profiles using information from third parties includes the steps of (a) accessing user activity with a computer, the computer being programmed to monitor the user activity; (b) the computer identifying the user activity and displaying a list of business types on a display of a user-controlled portable device by communicating with the portable device over a computer network; (c) the computer enabling the user to select a business type from the list of business types for a business that is identified by the computer based on the user activity; (d) the computer prompting the user by further communication with the portable device to input information relating to the business; (e) the computer determining the validity of the input information by comparing the input information with alternative information stored in a database of the computer and from other users; (f) the computer transforming the input information into directory information when the validity of the input information is verified in step (e); and (g) the computer combining the directory information from step (f) with transaction information identified from the user activity to create a business profile.

Step (b) may be practiced by the computer displaying an activity feed that includes the user activity and by flagging merchants on the activity feed for creation of the business profile. Step (c) may be practiced by enabling the user to select the business type of one or more of the flagged merchants on the activity feed. Step (d) may be practiced by providing an incentive for the user to provide the input information. The incentive may include rewards points or a special offer from a merchant or a financial award. The incentive may be awarded when the validity of the input information is verified in step (e). The computer may automatically add the business profile to a database of existing profiles, where the database of existing profiles may be accessible to the user. Step (g) further includes the computer including the alternative information as part of the business profile. Steps (a) and (b) may be practiced by monitoring user credit/debit card transactions.

In another exemplary embodiment, a computer system for creating business profiles using information from third parties includes a memory storing computer programs and a processor that executes the computer programs stored in the memory. A transaction monitoring module accesses and monitors user purchasing activity, and a communication module enables the computer system to communicate with a user-controlled portable device. The portable device includes a display and a user interface, and the transaction monitoring module is cooperable with the communication module to display a list of business types on the display of the portable device. An information request module enables the user to select a business type from the list of business types for a business that is identified by the transaction monitoring module based on the user purchasing activity. The information request module prompts the user by further communication with the portable device to input information relating to the business. A validity module determines the validity of the input information by comparing the input information with alternative information stored in the memory and from other users. The validity module transforms the input information into directory information when the validity of the input information is verified. A database combines the directory information with transaction information identified from the user purchasing activity and creates a business profile.

In yet another exemplary embodiment, a computer system for creating business profiles using information from third parties includes at least one user computer running a computer program that enables a user to indicate a business type for one or more merchants, and a system server running a server program. The at least one user computer and the system server are interconnected by a computer network. The system server prompts the user to input information relating to the one or more merchants and determines the validity of the input information. The system server transforms the input information into directory information when the validity of the input information is verified.

### BRIEF DESCRIPTION OF THE DRAWINGS

These and other aspects and advantages will be described in detail with reference to the accompanying drawings, in which:

FIGS. 1-4 show exemplary screen images for the system and method according to preferred embodiments;

FIG. 5 is a schematic block diagram of the computer system; and

FIG. 6 is a detailed schematic of a computer system.

### DETAILED DESCRIPTION OF THE INVENTION

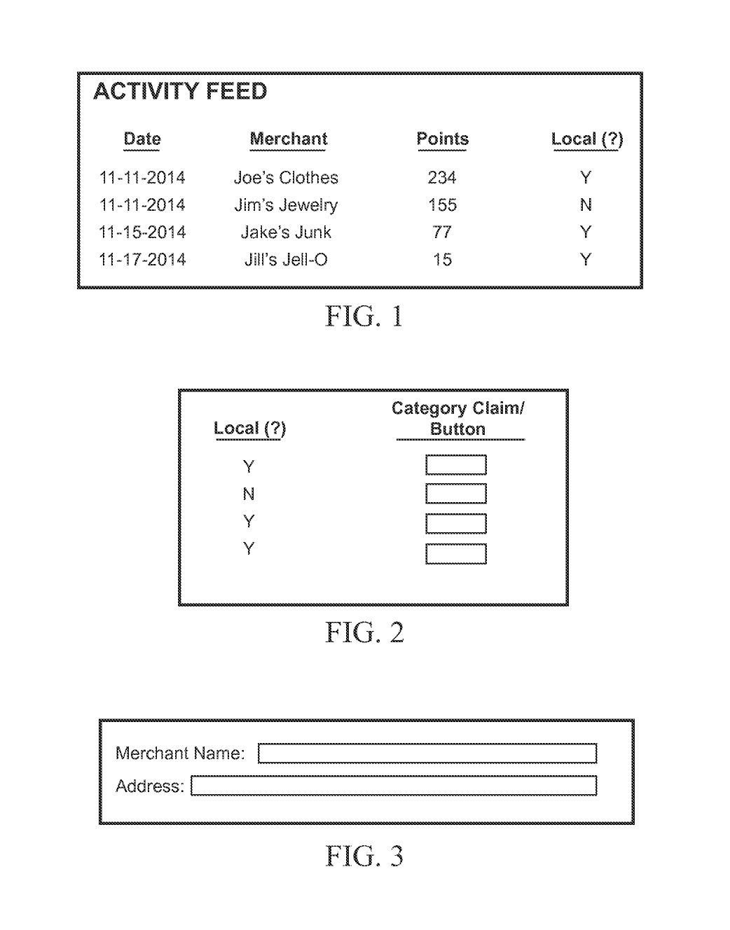

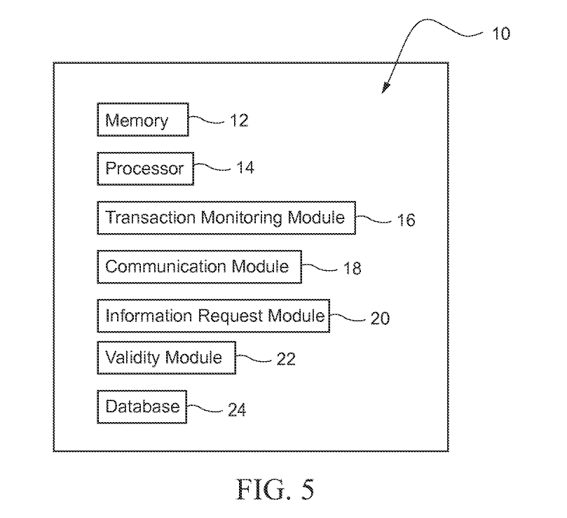

With reference to the drawings, crowd-source business onboarding can be achieved using hardware/software modules that form part of a computer system 10 (FIG. 5). The computer system 10 includes, among other things, a memory 12 storing computer programs and a processor 14 that executes the computer programs stored in the memory 12. A transaction monitoring module 16 accesses and monitors user purchasing activity. For example, a user shops at a certain business, and this activity is monitored by the transaction monitoring module 16. The transaction monitoring module 16 may be associated with the user's credit/debit card or other form of payment to identify and monitor user transactions. In an exemplary application, the user may see a summary of their shopping activity on an activity feed (FIG. 1).

A communication module 18 enables the computer system to communicate with a user-controlled portable device such as a smart phone, tablet, laptop or the like. The portable device includes a display and a user interface, where the transaction monitoring module 16 is cooperable with the communication module 18 to display a list of business types on the display of the portable device. An information request module 20 enables the user to select a business type from the list of business types for a business that is identified by the transaction monitoring module 16 based on the user purchasing activity. That is, after conducting a transaction at one or more merchants, the user's activity feed may list merchant names or the like for the user transactions, and the user is provided with an ability to mark a merchant as a certain category type by providing only basic information (FIG. 2). The information request module 20 prompts the user by further communication with the portable device to input information relating to the business. Such additional information should also be readily available to the user, and the user completes the information to be provided to the system server (FIG. 3).

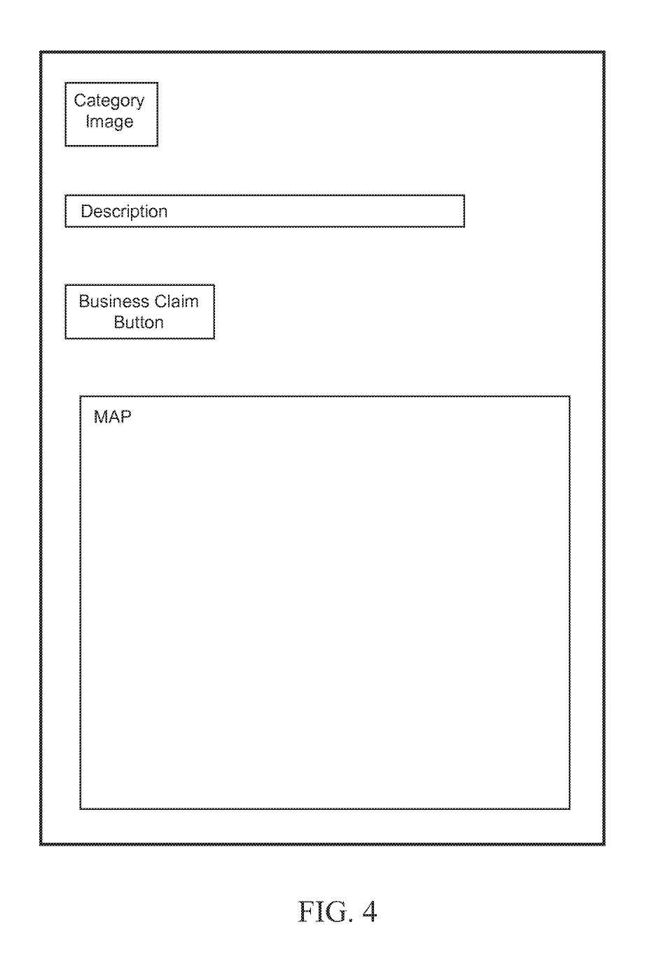

A validity module 22 determines the validity of the input information by comparing the input information with alternative information stored in the memory 12 and from other users. The validity module 22 transforms the input information into directory information when the validity of the information is verified. That is, the system server receives the request and runs the data against outside and inside databases to determine the validity of the request. Exemplary data stored in outside databases may include Name of Location, Owner Name, Address, Phone Number, Description, External IDs to connect with Other Databases (such as social media), etc. Exemplary data stored in internal databases may include Merchant ID, Transaction History, History of Bin numbers, Known External IDs, etc. A database 24 combines the directory information with transaction information identified from the user purchasing activity and creates a business profile. That is, if the system server determines that the request is valid, information is mined from public resources determining important information for the business including, without limitation, the company name, location and category type. The data collected is combined with the transaction description, coordinates of the transaction (i.e., the location of the transaction to a detailed resolution), and all other data capable of being pulled from a transaction to create a page for the business. That is, the system has access to information from the merchant/business based on the user's credit/debit card use or the like. The business is then automatically enabled within the system, and benefits of the directory are enabled for all future transactions (FIG. 4).

The discovery process run by the servers is a function generated by the information obtained through propriety software, in which the system administrator has information regarding transaction descriptions, location of the transaction, and the time that a transaction took place. This enables an algorithm to run comparing that information with databases to efficiently and correctly determine the viability of the crowd-sourced information. Validity can be completed since the information already in possession on the company gives the system references for determining whether the other information is accurate. If the system determines that the crowd-sourced information is incorrect, the button will disappear from all transactions by the user for that particular business, thereby reducing the total amount of possible misinformation for the user.

Users may be rewarded for their community knowledge by correct information leading to a correction in their activity at the business. This reward can be in the form of reputation or some kind of financial reward (such as award points or special offers). The incentive may be awarded when the validity of the input information is verified.

The crowd-source creation of business profiles described with reference to FIGS. 1-5 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:

the transfer protocol (e.g., http://); and

the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the crowd-source creation of business profiles of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

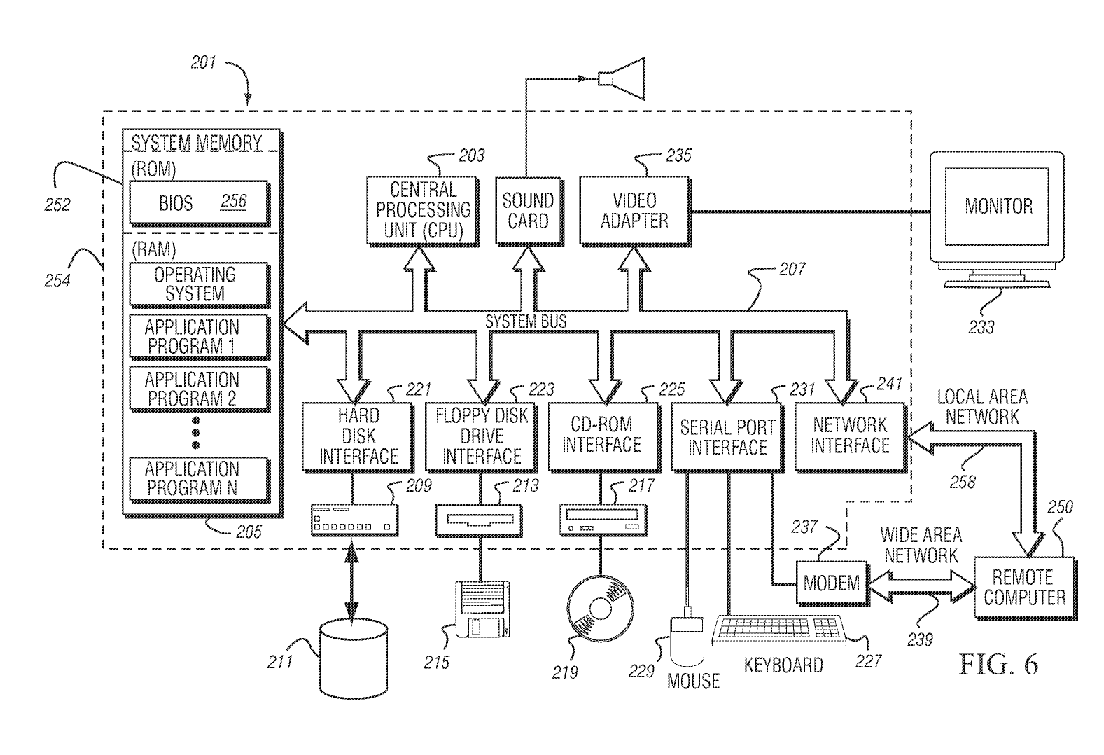

FIG. 6 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

By accessing the collective knowledge of a user base community, a computer system can quickly and efficiently determine all necessary business information while also weeding out unnecessary information. In addition, creating a process of determining information from crowd-sourced leads and reconciling the information with proprietary information will improve user experience and cut down company costs immediately upon implementation.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A computer method of creating business profiles using information from third parties, the method comprising:
(a) accessing user activity with a computer, the computer being programmed to monitor the user activity;
(b) the computer identifying the user activity and displaying a list of business types on a display of a user-controlled portable device by communicating with the portable device over a computer network;
(c) the computer enabling the user to select a business type from the list of business types for a business that is identified by the computer based on the user activity;
(d) the computer prompting the user by further communication with the portable device to input information relating to the business;
(e) the computer determining the validity of the input information by comparing the input information with alternative information stored in a database of the computer and from other users;
(f) the computer transforming the input information into directory information when the validity of the input information is verified in step (e); and
(g) the computer combining the directory information from step (f) with transaction information identified from the user activity to create a business profile.

2. A computer method according to claim 1, wherein step (b) is practiced by the computer displaying an activity feed that includes the user activity and by flagging merchants on the activity feed for creation of the business profile.

3. A computer method according to claim 2, wherein step (c) is practiced by enabling the user to select the business type of one or more of the flagged merchants on the activity feed.

4. A computer method according to claim 1, wherein step (d) is practiced by providing an incentive for the user to provide the input information.

5. A computer method according to claim 4, wherein the incentive comprises rewards points or a special offer from a merchant or a financial award.

6. A computer method according to claim 5, wherein the incentive is awarded when the validity of the input information is verified in step (e).

7. A computer method according to claim 1, further comprising the computer automatically adding the business profile to a database of existing profiles, wherein the database of existing profiles is accessible to the user.

8. A computer method according to claim 1, wherein step (g) further comprises the computer including the alternative information as part of the business profile.

9. A computer system according to claim 1, wherein steps (a) and (b) are practiced by monitoring user credit/debit card transactions.

10. A computer system for creating business profiles using information from third parties, the computer system comprising:
a memory storing computer programs;
a processor that executes the computer programs stored in the memory;
a transaction monitoring module that accesses and monitors user purchasing activity;
a communication module that enables the computer system to communicate with a user-controlled portable device, wherein the portable device includes a display and a user interface, and wherein the transaction monitoring module is cooperable with the communication module to display a list of business types on the display of the portable device;
an information request module that enables the user to select a business type from the list of business types for a business that is identified by the transaction monitoring module based on the user purchasing activity, the information request module prompting the user by further communication with the portable device to input information relating to the business;
a validity module that determines the validity of the input information by comparing the input information with alternative information stored in the memory and from other users, the validity module transforming the input information into directory information when the validity of the input information is verified; and
a database that combines the directory information with transaction information identified from the user purchasing activity and creates a business profile.

11. A computer system according to claim 10, wherein the communication module and the information request module are programmed to display an activity feed that includes the user activity and to flag merchants on the activity feed for creation of the business profile.

12. A computer system according to claim 11, wherein the portable device includes a user interface, and wherein the information request module activates the user interface to enable the user to select the business type of one or more of the flagged merchants on the activity feed.

13. A computer system according to claim 10, wherein the database is configured to automatically add the business profile to a collection of existing profiles, wherein the collection of existing profiles is accessible to the user.

14. A computer system according to claim 10, wherein the database is configured to include the alternative information as part of the business profile.

15. A computer system for creating business profiles using information from third parties, the computer system comprising:
at least one user computer running a computer program that enables a user to indicate a business type for one or more merchants; and
a system server running a server program, the at least one user computer and the system server being interconnected by a computer network, the system server prompting the user to input information relating to the one or more merchants and determining the validity of the input information,
wherein the system server transforms the input information into directory information when the validity of the input information is verified.

16. A computer system according to claim 15, wherein the system server accesses transaction information from a user credit/debit card, and wherein the system server prompts the user to input the input information based on the transaction information.

17. A computer system according to claim 16, wherein the system server combines the directory information with the transaction information to create the business profile.
